(19) United States
(12) Patent Application Publication
(10) Pub. No.: US 2018/0285231 A1
(43) Pub. Date: Oct. 4, 2018

(54) COMMUNICATION APPARATUS, DATA ACQUISITION SYSTEM, AND DATA ACQUISITION CONTROL METHOD

(71) Applicant: FUJITSU LIMITED, Kawasaki-shi (JP)

(72) Inventor: Jun Kakuta, Yokohama (JP)

(73) Assignee: FUJITSU LIMITED, Kawasaki-shi (JP)

(21) Appl. No.: 15/936,564

(22) Filed: Mar. 27, 2018

(30) Foreign Application Priority Data
Mar. 31, 2017 (JP) 2017-071467

(51) Int. Cl. G06F 11/34; H04L 12/26; H04W 4/38; G06F 11/30

(52) U.S. Cl. CPC G06F 11/34; G06F 11/3062; H04W 4/38; H04L 43/103

(57) ABSTRACT

A communication apparatus includes a first memory; a second memory; and a processor configured to store data acquisition requests received from the application in the first memory, acquire sensor data from a sensor, store the sensor data acquired from the sensor in the second memory, determine a system condition based on the data acquisition requests stored in the first memory and the sensor data stored in the second memory, and switch a method of acquiring sensor data from the sensor based on the determined system condition.

### CROSS-REFERENCE TO RELATED APPLICATION

This application is based upon and claims the benefit of priority of the prior Japanese Patent Application No. 2017-71467, filed on Mar. 31, 2017, the entire contents of which are incorporated herein by reference.

### FIELD

The embodiments discussed herein are related to a communication apparatus, a system, and a control method to control reception of information from devices.

### BACKGROUND

Internet-of-things (IoT) systems, in which sensors are installed to acquire data of environmental information or the like and plural services utilize the acquired data, are increasingly spreading. The IoT system acquires data on demand or makes notifications when sensor devices used by the system change in state, depending on service functions provided by the system and the sensor devices.

In many IoT systems, sensors are connected to a cloud through a device called a gateway. The gateway is limited in performance of the central processing unit (CPU) and memory capacity and has difficulty in high-load processing. The sensors have limitations in CPU performance and battery capacity and have difficulty in responding to frequent requests for acquiring data. Furthermore, the field area network between the gateway and the sensors has limitations in the communication band and stability. Accordingly, communication delays may occur between the gateway and many sensors and highly-frequent communications. These loads may be reduced by setting longer time intervals at which the IoT system acquires data from sensors. However, if the intervals at which the IoT system acquires data are equally changed, it is difficult to acquire data timely when each application uses such data.

Herein, as an example of the related arts, Japanese Laid-open Patent Publication No. 2011-228851 discusses a mobile terminal as follows. The mobile terminal includes a position sensor. The mobile terminal further includes an acceleration sensor that measures vertical accelerations and stores the measurement result in a storage. The mobile terminal further includes an analyzer that, when detecting periodical vibration from the measurement result stored in the storage, calculates the current vibration period and amplitude using the measurement result. The mobile terminal still further includes a change rate calculator that, when the current vibration period is determined as a vibration period obtained when the mobile terminal is on a farm vehicle, calculates the ratio of the current amplitude to the amplitude at the time when the previous position data was acquired, as a change rate of amplitude. The mobile terminal still further includes a controller that determines whether the change rate of amplitude is out of a predetermined range and that causes the position sensor to acquire position data when the change rate of amplitude is out of the predetermined range.

As another example of the related arts, Japanese Laid-open Patent Publication No. 2012-104943 discusses a data acquisition frequency controller as follows. The data acquisition frequency controller includes a situation information storage that stores situation information to associate a target detection sensor device with one or plural related sensor devices related to the target detection sensor device, the target detection sensor device being configured to detect a target among a plurality of sensor devices. The data acquisition frequency controller includes a transmission frequency change instruction section that, based on the target detected data acquired from the target detection sensor device, instructs the target detection sensor device and/or each related sensor device that is recognized as being related to the target detection sensor device with reference to the situation information to change the transmission frequency of data.

However, the aforementioned related arts are configured to control data acquisition based on the relationship with the other sensors. The aforementioned related arts do not achieve both load reduction and data acquisition appropriate for applications when the load on the system (including a gateway, a sensor, and a field area network) increases.

### SUMMARY

According to an aspect of the embodiments, a communication apparatus includes a first memory; a second memory; and a processor configured to store data acquisition requests received from the application in the first memory, acquire sensor data from a sensor, store the sensor data acquired from the sensor in the second memory, determine a system condition based on the data acquisition requests stored in the first memory and the sensor data stored in the second memory, and switch a method of acquiring sensor data from the sensor based on the determined system condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are explanatory diagrams for a data acquisition method;

FIG. 2 is a block diagram illustrating a configuration example of a gateway of a first embodiment;

FIG. 3 is a block diagram illustrating a configuration example of a gateway of a second embodiment;

FIG. 4 is a block diagram illustrating a configuration example of a gateway of a third embodiment;

FIG. 5 is a block diagram illustrating a network configuration example of a system including a server, a gateway, and sensors as an embodiment;

FIG. 6 is a flowchart illustrating an entire process example of the embodiment;

FIG. 7 is a flowchart of a process to switch the data acquisition method from an on-demand mode to a notification-per-change mode in the embodiment;

FIG. 8 is a diagram illustrating a sensor pattern example when data does not change;

FIG. 9 is a flowchart (No. 1) of a process to switch the notification-per-change mode to the on-demand mode in the embodiments;

FIG. 10 is a flowchart (No. 2) of the process to switch the notification-per-change mode to the on-demand mode in the embodiments;

FIG. 11 is a diagram illustrating a sensor pattern example when data changes frequently by a small amount;

FIG. 12 is a block diagram illustrating a hardware configuration example of a gateway capable of implementing the embodiments;

FIG. 13 is a block diagram illustrating a hardware configuration example of a server capable of implementing the embodiments; and

FIG. 14 is a block diagram illustrating a hardware configuration example of a sensor capable of implementing the embodiments.

### DESCRIPTION OF EMBODIMENTS

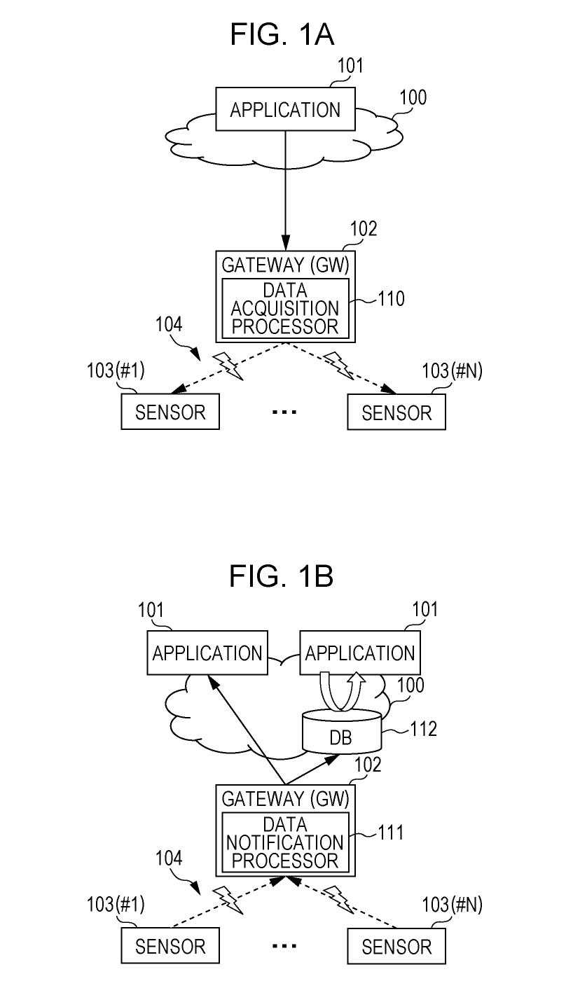

Hereinafter, a description is given of embodiments for carrying out the disclosure with reference to the drawings. FIG. 1A is an explanatory diagram of an on-demand mode, and FIG. 1B is an explanatory diagram of a notification-per-change mode.

First, in the on-demand mode of FIG. 1A, the following operation is executed. Sensor apparatuses (hereinafter referred to as sensors) 103#1 to 103#N (N is a natural number not less than 1) communicate with a gateway 102 via a wireless network 104, for example. The network 104 may be a wired network. The gateway (hereinafter, abbreviated as a GW) 102 communicates with an application program (hereafter, abbreviated as an application) 101 that operates on a server apparatus (hereinafter, abbreviated as a server) via a wired network 100, for example. The network 100 may be a wireless network. The application 101 requests a data acquisition processor 110, which is executed on the GW 102, to perform regular data acquisition. Based on the request, the data acquisition processor 110 acquires data from each of the sensors 103#1 to 103#N and returns the result thereof to the application 101.

Next, in the notification-per-change mode of FIG. 1B, the following operation is executed. An application 101 previously specifies one of the sensors 103#1 to 103#N and requests a data notification processor 111, which is executed on the GW 102, to execute notification when the output value of the specified sensor 103 changes. Based on the request, the data notification processor 111 configures the specified sensor 103 among the sensors 103#1 to 103#N for notification. The thus configured sensor 103 measures data regularly and notifies the GW 102 of the measured data only when the measured data has a change from the previous measured data. The data notification processor 111, which operates in the GW 102, notifies the application 101 of the received measured data with the change. Instead of notifying the application 101 of the measured data that with the change, the data notification processor 111 may store the measured data into a database (DB) 112 which operates in a server apparatus in the network 100. In such a case, the application 101 refers to the DB 112 regularly.

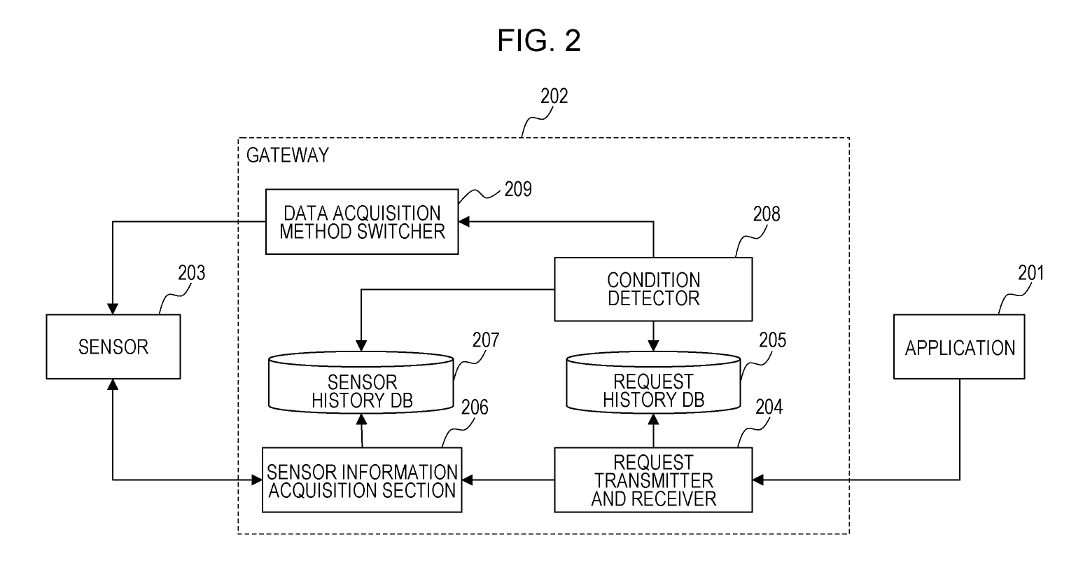

Similarly to the cases of FIGS. 1A and 1B, FIG. 2 is a block diagram illustrating a configuration example of a first embodiment of the GW 202 (a communication apparatus) in a data acquisition system in which an application 201 (corresponding to the application 101 in FIGS. 1A and 1B), a GW 202 (corresponding to the GW 102 in FIGS. 1A and 1B), and a sensor 203 (corresponding to the sensors 103 in FIGS. 1A and 1B) communicate with each other.

The GW 202 includes a request transmitter and receiver 204, a request history database (hereinafter, abbreviated as a request history DB) 205, a sensor information acquisition section 206, and a sensor history database (hereinafter, abbreviated as a sensor history DB) 207. The GW 202 further includes a condition detector 208 and a data acquisition method switcher 209.

The request transmitter and receiver 204 receives and responds to data acquisition requests from the application 201 which operates in a server apparatus (not particularly illustrated).

The request history DB 205 stores the history of data acquisition requests received by the request transmitter and receiver 204 from the application 201. The history includes the interval of data acquisition requests from the application 201, for example.

The sensor information acquisition section 206 acquires and receives data (hereinafter, referred to as sensor data) from the sensor 203.

The sensor history DB 207 stores the history of sensor data that the sensor information acquisition section 206 receives from the sensor 203. The history includes the sensor data and intervals of notifications of sensor data, for example.

The condition detector 208 determines the system condition based on the data acquisition requests that are received from the application 201 and stored in the request history DB 205 and the sensor data that are received from the sensor 203 and stored in the sensor history DB 207. The system condition determined by the condition detector 208 includes the load of the system, that is, GW 202, or the battery level of the sensor 203, for example. The load (or load value) of the system is calculated as the sum of the number of data acquisition requests from the application 201 per unit time and the number of data acquisitions from the sensor 203 per unit time, for example. The load of the system may be calculated based on operation load of the processor, memory usage, and use conditions of the communication interface, which are acquired from the operating system executed by the GW 202, for example. The load value may be calculated by weighting the frequency of data acquisitions from sensors 203 and the use condition of the communication interface concerning communication with the sensor 203 depending on the number of sensors 203 connected to the GW 202. The system load may include traffic conditions of the network 100 that connects the sensor 203 and GW 202 and that connects GW 202 and application 201.

The data acquisition method switcher 209 switches the method of acquiring data from the sensor 203 to the GW 202, from a first data acquisition mode to a second data acquisition mode based on the system condition determined by the condition detector 208. The data acquisition method switcher 209 switches the data acquisition method between the on-demand mode (FIG. 1A) and the notification-per-change mode (FIG. 1B) based on the system condition detected by the condition detector 208, for example.

According to the first embodiment, it is possible to achieve both load reduction of the system and data acquisition at an appropriate time for applications even when the load on the system increases. To achieve the aforementioned load reduction and appropriate data acquisition is more important especially when the performances of the sensors and GW are limited or when data acquisition requests from applications are received frequently. Additionally, when the network through which the GW 202 and each sensor 203 communicate or the network through which the GW 202 and application 201 communicate tends to be congested, changing the data acquisition method to the notification-per-change mode will reduce the incidence of congestion. Furthermore, the method of acquiring data from each sensor 203 may be selected from the on-demand mode and the notification-per-change mode depending on the battery level of the sensor 203. This reduces the rate of decrease in the battery level of the sensor 203. Selecting the data acquisition method in such a manner allows for control of the first embodiment based on the sensor data acquired from one (individual) sensor 203 without being influenced by the relationship with the other sensors.

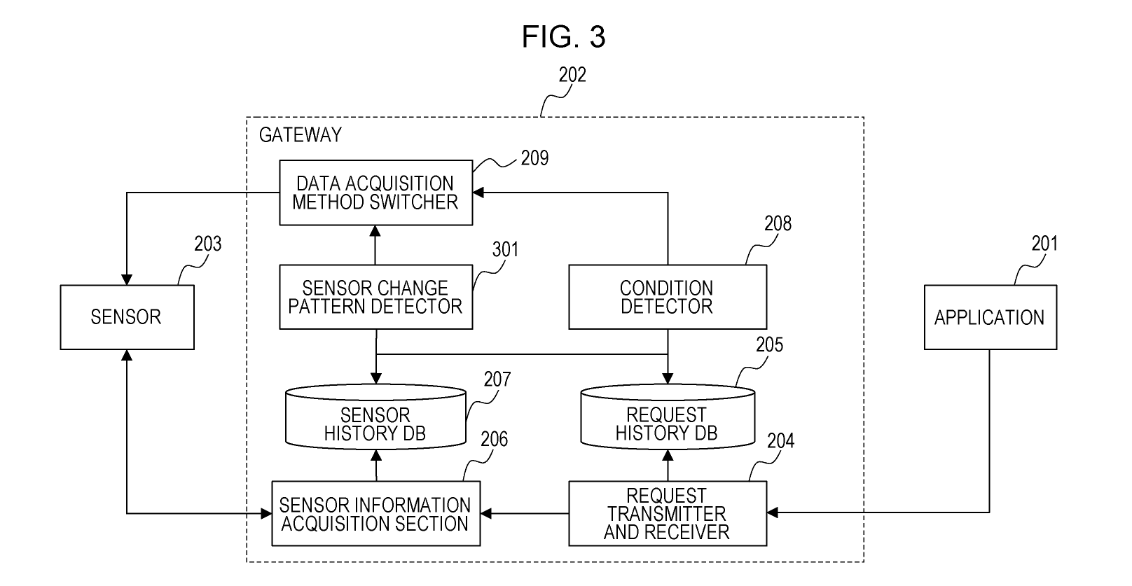

Similarly to the cases of FIGS. 1A and 1B, FIG. 3 is a block diagram illustrating a configuration example of a second embodiment of the GW 202 in the data acquisition system in which the application 201 (corresponding to the application 101 in FIGS. 1A and 1B), the GW 202 (corresponding to the GW 102 in FIGS. 1A and 1B), and the sensor 203 (corresponding to the sensors 103 in FIGS. 1A and 1B) communicate with each other. In the configuration of FIG. 3, the components given the same numbers as those in FIG. 2 execute the same functions as those in the case of FIG. 2. The configuration of FIG. 3 is different from that of FIG. 2 in further including a sensor change pattern detector 301.

The sensor change pattern detector 301 detects a change pattern of sensor data based on the sensor data stored in the sensor history DB 207.

The data acquisition method switcher 209 switches the data acquisition method based on the system condition detected by the condition detector 208 in the same manner as the first embodiment. The data acquisition method switcher 209 also switches the data acquisition method between the on-demand mode of FIG. 1A and the notification-per-change mode of FIG. 1B based on the change pattern of sensor data detected by the sensor change pattern detector 301. In a process of the on-demand mode, for example, the interval at which data from each sensor is acquired is determined based on the change pattern of sensor data detected by the sensor change pattern detector 301. Even when the load on the GW 202 (FIG. 3) and the network (hereinafter, referred to as a field area network) connecting the GW 202 and sensor 203 increases, it is possible to reduce the likelihood of overloading the system and implement data acquisition at an appropriate time. Even in the case of acquiring data from one single (individual) sensor 203, the control of the second embodiment is implemented without being influenced by the other sensors.

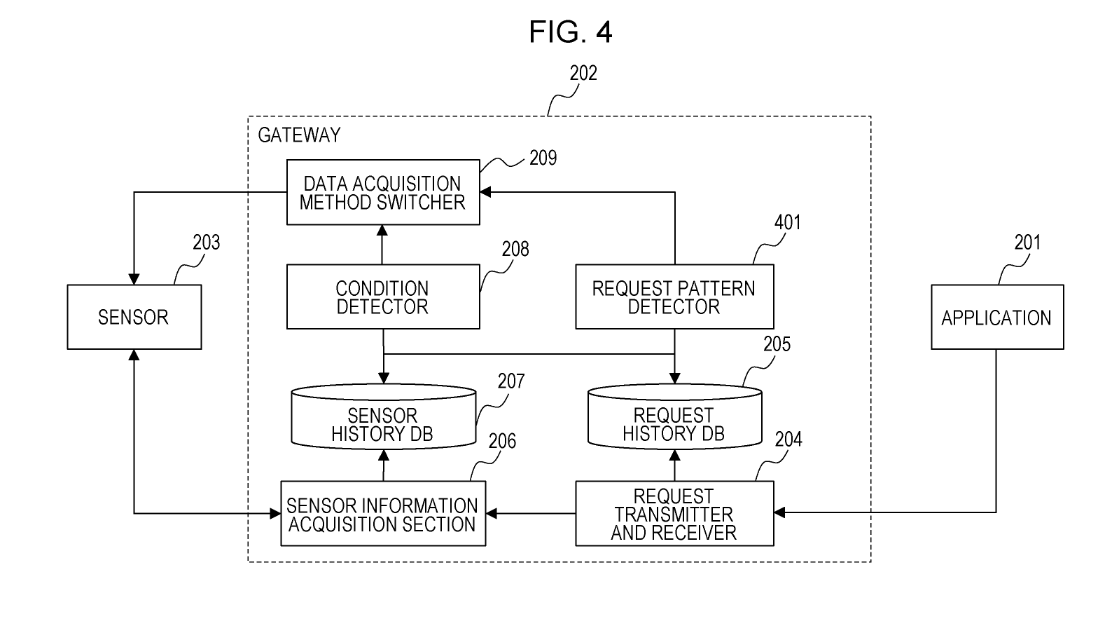

Similarly to the cases of FIGS. 1A and 1B, FIG. 4 is a block diagram illustrating a configuration example of the third embodiment of the GW 202 in the data acquisition system in which the application 201 (corresponding to the application 101 in FIGS. 1A and 1B), the GW 202 (corresponding to the GW 102 in FIGS. 1A and 1B), and the sensor 203 (corresponding to the sensors 103 in FIGS. 1A and 1B) communicate with each other. In the configuration of FIG. 4, the components given the same numbers as those in FIG. 2 execute the same functions as those in the case of FIG. 2. The configuration of FIG. 4 is different from that of FIG. 2 in further including a request pattern detector 401.

The request pattern detector 401 detects a request pattern of data acquisition requests based on data acquisition requests from the application 201 that are stored in the request history DB 205.

The data acquisition method switcher 209 changes the data acquisition method based on the system condition detected by the condition detector 208 in the same way as the first embodiment. Based on the pattern of data acquisition requests from the application 201 that is detected by the request pattern detector 401, the data acquisition method switcher 209 changes the interval at which sensor data of each sensor 203 is acquired in the on-demand mode and switches the data acquisition method between the modes illustrated in FIGS. 1A and 1B.

In such a manner, the data acquisition method is switched considering the pattern of data acquisition requests (hereinafter, referred to as a request pattern) from the application 201 in addition to the system condition detected by the condition detector 208. According to the third embodiment, it is therefore possible to achieve both load reduction of the system and data acquisition at an appropriate time for applications even when the load on the system increases. In this process, the control of the third embodiment is implemented without being influenced by the other sensors even in the case of acquiring sensor data from one (individual) sensor 203. It is also possible to avoid congestion in the network that connects the GW 202 and the server in which the application 201 is executed.

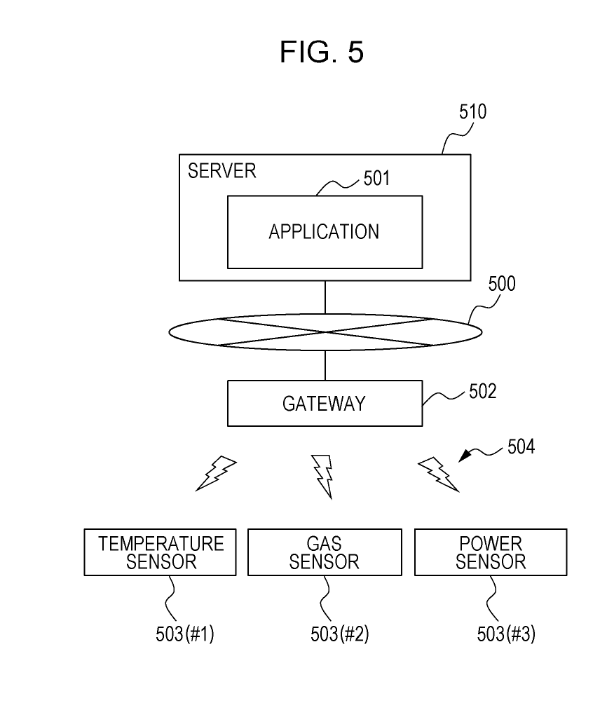

FIG. 5 is a block diagram illustrating a network configuration example of the system including a server, a GW, and sensors, as an embodiment. As an example, sensors 503#1 to 503#3 (corresponding to the sensors 203 in FIGS. 2 to 4) communicate with a GW 502 via a wireless field area network 504, for example. The field area network 504 may be a wired network. The sensors 503#1 to 503#3 are a temperature sensor, a CO₂ gas sensor, and a power sensor, respectively. The number of the sensors 503 communicating with the GW 502 is not limited to three. A large number of sensors 503 may communicate with the GW 502. The GW 502 (corresponding to the GW 202 in FIGS. 1 to 4) communicates with an application 501 (corresponding to the application 201 in FIGS. 2 to 4) that operates on a server 510 via a wired network 500. The network 500 may be a wireless network.

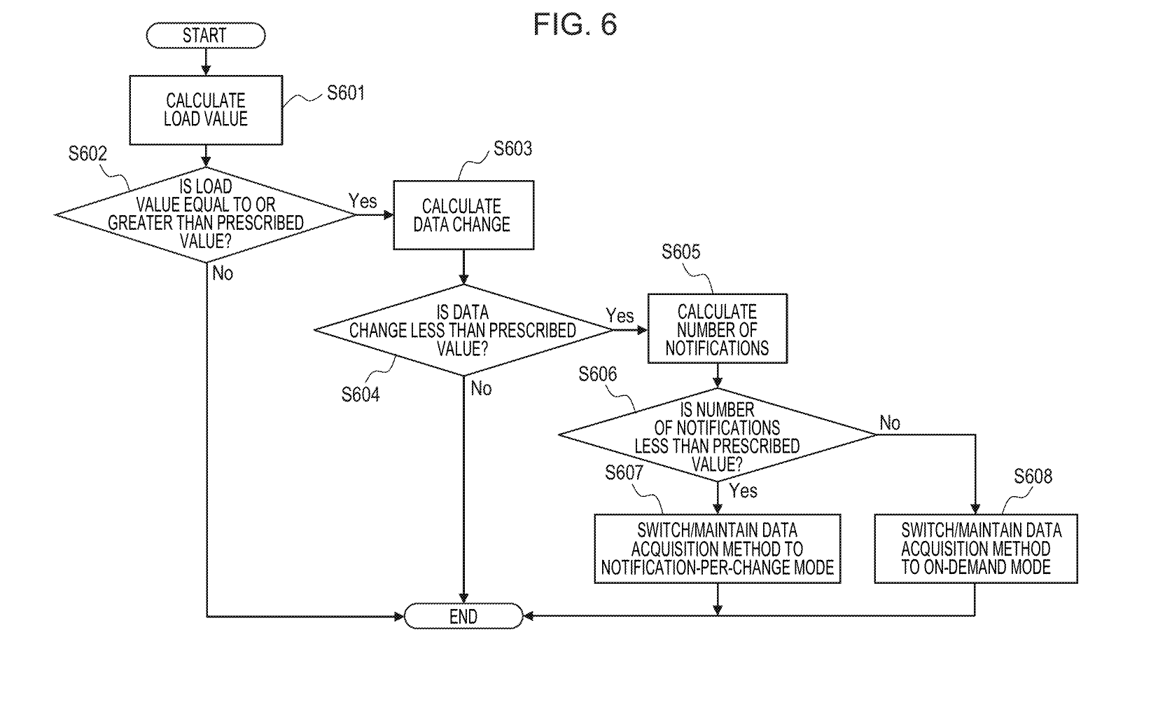

FIG. 6 is a flowchart illustrating an example of an entire control process executed by the constituent components described in FIGS. 2 to 4 in the first to third embodiments. The control process may be commonly executed for sensors 203, which correspond to the sensors 503 in FIG. 5, or may be sequentially executed for each sensor 203.

The following description of flowcharts in FIGS. 6, 7, 9, and 10 properly refers to the components of the configurations of the first to third embodiments illustrated in FIGS. 2 to 4.

First, the condition detector 208 calculates a system load value that indicates the degree of load on the GW 202 (step S601). The system load value is calculated as the sum of the number of data acquisition requests from the application per unit time and the number of data acquisitions from the sensor 203 per unit time, for example. The system load value may be also calculated based on the use conditions of the processor, memory, and communication interface, which may be acquired from the operating system executed by the GW 202.

Next, the data acquisition method switcher 209 determines whether the system load value calculated in the step S601 is equal to or greater than the prescribed value (step S602).

When the system load value is less than the prescribed value (No in the step S602), the data acquisition method switcher 209 maintains the current data acquisition method for the sensor 203 and terminates the current entire control process illustrated by the flowchart in FIG. 6.

When the system load value is equal to or greater than the prescribed value (Yes in the step S602), the sensor change pattern detector 301 calculates a change during each given time (hereinafter, referred to as a data change), in sensor data (measured values) from the sensor 203 which are stored in the sensor history DB 207 (step S603). The data change refers to a change rate of values of sensor data per unit time, a time series variation of the change rate per unit time, the period of values of sensor data in a unit time, or the like, for example.

Next, the data acquisition method switcher 209 determines whether the data change calculated in the step S603 is less than a prescribed value (step S604).

When the data change is not less than the prescribed value (No in the step S604), the data acquisition method switcher 209 illustrated in FIG. 3 maintains the current data acquisition method for the sensor 203 and terminates the current entire control process illustrated by the flowchart in FIG. 6.

When the data change is less than the prescribed value (Yes in step S604), the data acquisition method switcher 209 calculates the number of notifications of sensor data from the sensor 203 in a given period of time with reference to the sensor history DB 205, for example (step S605).

The data acquisition method switcher 209 then determines whether the number of notifications calculated in the step S605 is less than a prescribed value (step S606).

When the number of notifications is not less than the prescribed value (No in the step S606), that is, when the sensor 203 issues many notifications of sensor data, the data acquisition method switcher 209 switches the current data acquisition method to the on-demand mode (step S608). This is because acquiring data each time the data changes increases the system load. When the current data acquisition method is the on-demand mode, the data acquisition method switcher 209 maintains the current data acquisition method (step S608). The data acquisition method switcher 209 then terminates the current entire control process illustrated by the flowchart in FIG. 6.

When the number of notifications is less than the prescribed value (Yes in the step S606), that is, when the sensor 203 issues a few notifications of sensor data, the data acquisition method switcher 209 switches the current data acquisition method to the notification-per-change mode (step S607). When the current data acquisition method is the notification-per-change mode, the data acquisition method switcher 209 maintains the current data acquisition method (step S607). The data acquisition method switcher 209 then terminates the current entire control process illustrated by the flowchart in FIG. 6.

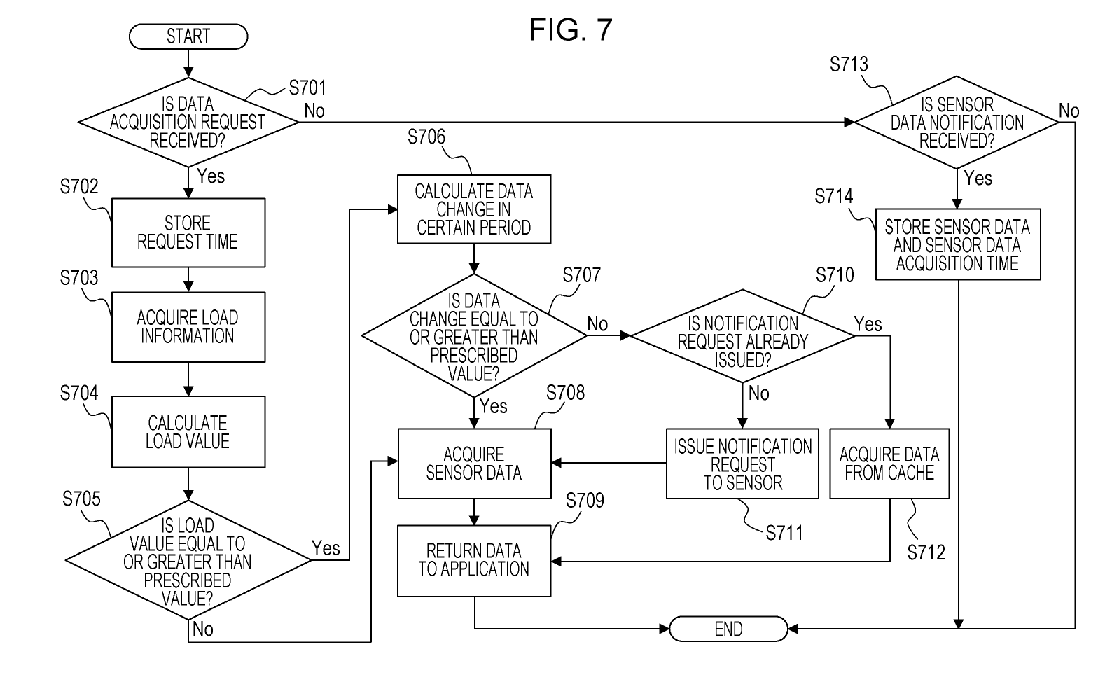

FIG. 7 is a flowchart illustrating a process to switch the data acquisition method from the on-demand mode to the notification-per-change mode in the step S607 (FIG. 6).

The application transmits data acquisition requests to the GW 202 regularly. The request transmitter and receiver 204 first determines whether a data acquisition request is received from the application 201 (step S701).

When any data acquisition request is not received (No in the step S701), the sensor information acquisition section 206 determines whether sensor data (measured value) is received from any of the sensors 203 (step S713).

When sensor data of the sensor 203 is received (Yes in the step S713), the sensor information acquisition section 206 records the received sensor data and data acquisition time in the sensor history DB 207 (step S714). The sensor information acquisition section 206 stores the latest sensor data corresponding to the sensor 203 in a cache.

When neither data acquisition request nor sensor data are received (No in the step S713), the current control process illustrated by the flowchart in FIG. 7 ends.

When a data acquisition request is received from the application 201 (Yes in the step S701), the request transmitter and receiver 204 records the data acquisition request and the time when the data acquisition request is received, in the request history DB 205 (step S702).

Next, the condition detector 208 acquires load information (step S703) and calculates the system load value based on the load information (step S704). This process is the same as that of the step S601 in FIG. 6 and is configured to calculate the system load value indicating the degree of load on the GW 202. The condition detector 208 calculates the current system load value based on the frequency of data acquisition requests from the application 201 and the frequency of data acquisitions from the sensor 203. The system load value is calculated as the sum of the number of data acquisition requests per unit time and the number of data acquisitions per unit time, for example.

Next, the data acquisition method switcher 209 determines whether the system load value calculated in the step S704 is equal to or greater than a prescribed value (step S705).

When the system load value is less than the prescribed value (No in the step S705), the data acquisition method does not have to be switched. The sensor information acquisition section 206 then transmits a direct request to the sensor 203 in accordance with the on-demand mode to acquire sensor data (step S708). The request transmitter and receiver 204 transmits the acquired sensor data to the application 201 as a response to the data acquisition request (step S709). The current control process illustrated in the flowchart of FIG. 7 then ends.

When the system load value is equal to or greater than the prescribed value (Yes in the step S705), the sensor change pattern detector 301 executes the following process. The sensor change pattern detector 301 calculates a data change per given time, in sensor data (measured value) of the sensor 203 stored in the sensor history DB 207 in the step S714 (step S706). This process is the same as that in the step S603 of FIG. 6.

Next, the data acquisition method switcher 209 determines whether the data change calculated in the step S706 is equal to or greater than a prescribed value (step S707).

When the data change is equal to or greater than the prescribed value (Yes in the step S707), the sensor information acquisition section 206 executes the following process. The sensor information acquisition section 206 transmits a direct request to the sensor 203 with the data acquisition method being in the on-demand mode to acquire sensor data (step S708). The request transmitter and receiver 204 transmits the acquired sensor data to the application 201 as a response to the data acquisition request (step S709). The current control process illustrated by the flowchart in FIG. 7 then ends (Yes in the step S707→S708→S709).

When the system load value is greater than the prescribed value and data change is less than the prescribed value (No in the step S707), the data acquisition method switcher 209 configures the sensor 203 for notification-per-change (step S711). When receiving sensor data that is changed, from the sensor 203, the sensor information acquisition section 206 stores the received data in a cache. The GW 202 acquires data only when the data is changed.

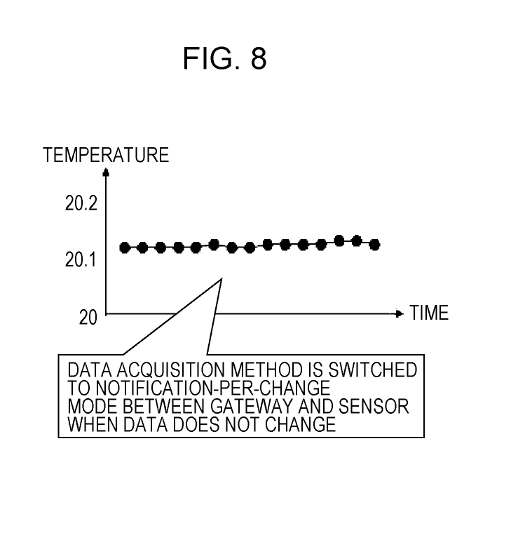

As an example of the operation to change the data acquisition method in accordance with the sensor pattern detected by the sensor change pattern detector 301, FIG. 8 is a diagram illustrating an example of the sensor pattern in the case where the data change is less than the prescribed value (No in the step S707). In other words, FIG. 8 illustrates a case where the data acquisition method is switched from the on-demand mode to the notification-per-change mode. More specifically, in the case of FIG. 8, the measured value of the sensor 203 which is set to the on-demand mode as the current data acquisition method does not change, and data acquisition does not have to be performed.

First, the data acquisition method switcher 209 determines whether a notification request, which requests for notification-per-change, is already issued to the sensor 203 (step S710).

When the notification request is not issued yet (No in the step S710), the data acquisition method switcher 209 issues to the sensor 203, a notification request (step S711). The data acquisition method switcher 209 then transmits a direct request to the sensor 203 to acquire sensor data (step S708), and the sensor information acquisition section 206 acquires sensor data (step S708). The request transmitter and receiver 204 transmits the acquired sensor data to the application 201 as a response to the data acquisition request (step S709). The current control process illustrated by the flowchart in FIG. 7 then ends. When a notification request is already issued (Yes in the step S710), the sensor information acquisition section 206 executes the following process. The sensor information acquisition section 206 acquires sensor data of the sensor 203 held in the cache in the step S714 (step S712). When receiving a data acquisition request from the application 201, the request transmitter and receiver 204 transmits the latest sensor data acquired from the cache to the application 201 as a response (step S709). The current control process illustrated by the flowchart in FIG. 7 then ends.

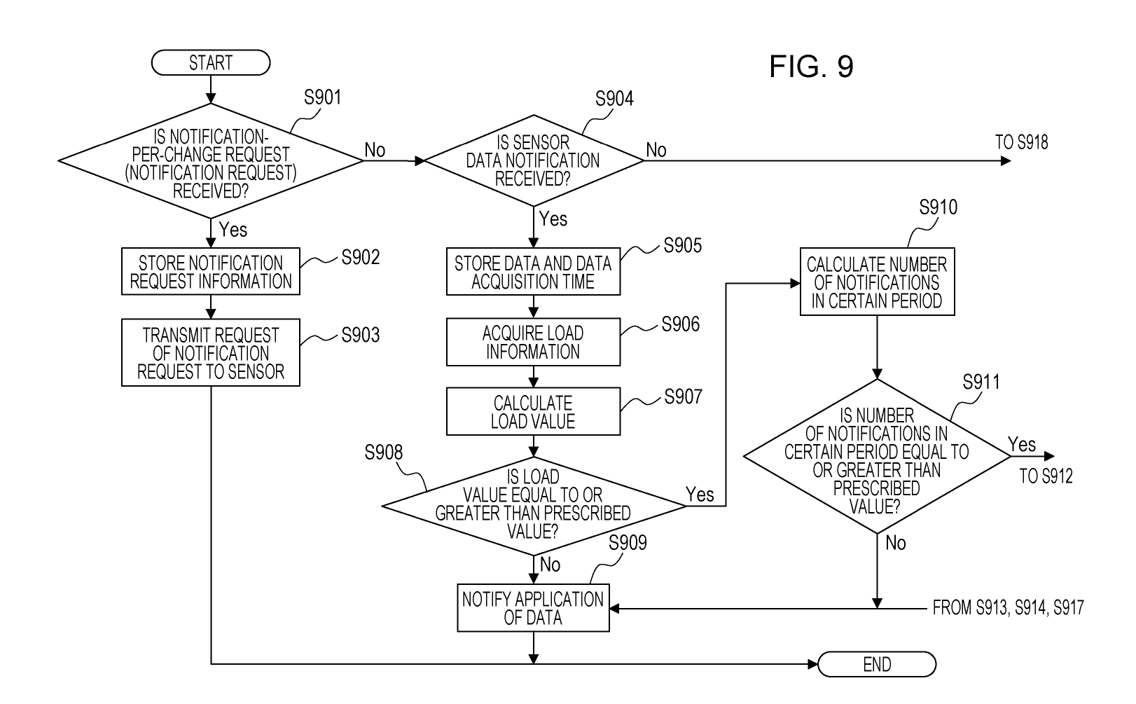

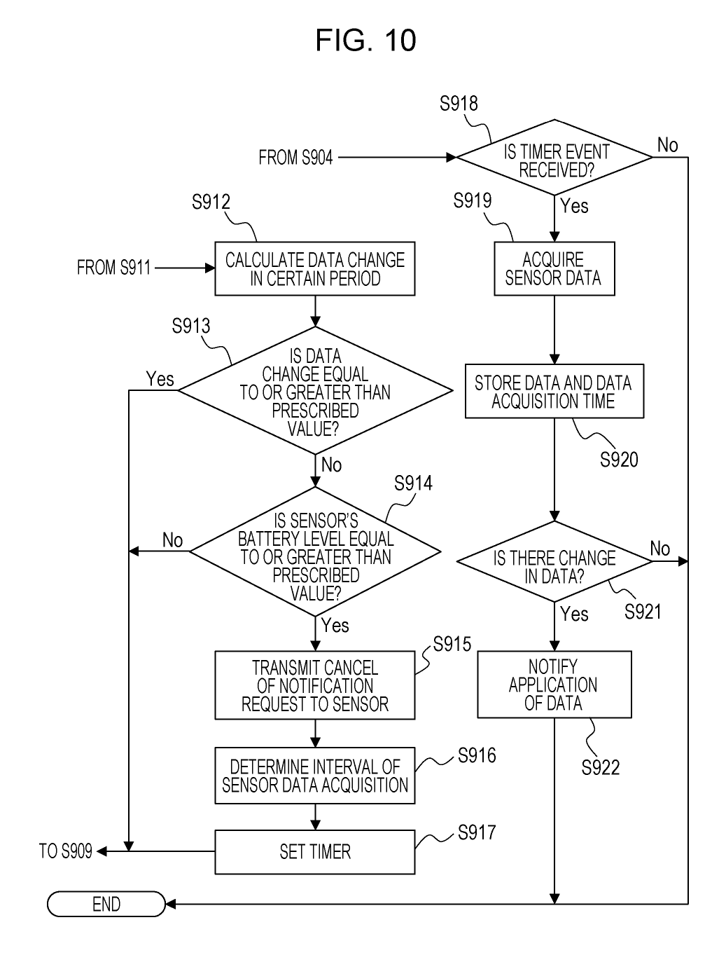

FIGS. 9 and 10 are flowcharts illustrating a process to switch the data acquisition method from the notification-per-change mode to the on-demand mode.

As the initial state, the application 201 transmits a request to acquire data from the sensor 203 in accordance with the notification-per-change mode (hereinafter, abbreviated as a notification-per-change request), to the GW 202. The request transmitter and receiver 204 determines whether a notification-per-change request is received from the application 201 (step S901).

When the request transmitter and receiver 204 receives the aforementioned notification-per-change request from the application 201 (Yes in the step S901), the request transmitter and receiver 204 records the notification-per-change request in the request history DB 205 (step S902).

The request transmitter and receiver 204 transmits a request corresponding to the notification-per-change request, to the target sensor 203 (step S903). Thereafter, the target sensor 203 transmits sensor data (measured value) to the GW 202 each time the measured value changes. After the step S903, the current control process illustrated by the flowcharts in FIGS. 9 and 10 ends.

When the request transmitter and receiver 204 has not received the notification-per-change request from the application 201 yet (No in the step S901), the sensor information acquisition section 206 determines whether sensor data is received from the sensor 203 (step S904).

When sensor data is received from the sensor 203 (Yes in the step S904), the sensor information acquisition section 206 executes the following process. The sensor information acquisition section 206 records the sensor data and data acquisition time in the sensor history DB 207 (step S905).

Next, the condition detector 208 acquires load information (step S906) and calculates the system load value based on the load information (step S907). This process is the same as that of the step S601 in FIG. 6 and is configured to calculate the system load value indicating the degree of load on the GW 202. The condition detector 208 calculates the current system load value based on the frequency of data acquisition requests from the application 201 and the frequency of data notifications from the sensors 203. The system load value is calculated as the sum of the number of data acquisition requests per unit time and the number of data notifications per unit time, for example.

Next, the condition detector 208 determines whether the system load value calculated in the step S907 is equal to or greater than a prescribed value (step S908).

When the system load value is less than the prescribed value (No in the step S908), the data acquisition method does not have to be switched, and the request transmitter and receiver 204 transmits (returns) the received sensor data to the application 201 (step S909). The current control process illustrated by the flowcharts in FIGS. 9 and 10 then ends.

When the system load value calculated in the step S907 is equal to or greater than the prescribed value (Yes in the step S908), the sensor change pattern detector 301 executes the following process. The sensor change pattern detector 301 calculates the number of data notifications from the sensor 203 in a given period with reference to the history of reception of sensor data that is recorded in the sensor history DB 205 (step S910).

The sensor change pattern detector 301 determines whether the number of data notifications calculated in the step S910 is equal to or greater than a prescribed value (step S911).

When the number of data notifications calculated in the step S910 is less than the prescribed value (No in the step S911), that is, when the sensor 203 does not frequently notify the GW 202 of sensor data, the request transmitter and receiver 204 executes the following process. Since the system load value will not be excessively high even if the data acquisition method remains in the notification-per-change mode, the request transmitter and receiver 204 transmits (returns) the received sensor data to the application 201 (step S909). The current control process illustrated in the flowcharts of FIGS. 9 and 10 then ends.

When the number of data notifications calculated in the step S910 is equal to or greater than the prescribed value (Yes in the step S911), the sensor change pattern detector 301 calculates a data change per given time, in sensor data (measured value) of the sensor 203 which is stored in the sensor history DB 207 by the step S905 of FIG. 9 (step S912 in the flowchart of FIG. 10).

Next, the data acquisition method switcher 209 determines whether the data change calculated in the step S912 is equal to or greater than a prescribed value (step S913).

When the data change is less than the prescribed value (No in the step S913), the condition detector 208 further determines whether the battery level of the sensor 203 that has transmitted the sensor data is equal to or greater than a prescribed value (step S914).

When the battery level is less than the prescribed value (No in the step S914), therefore, the data acquisition method switcher 209 withholds switching of the data acquisition method to the on-demand mode. This is because when the data acquisition method is the on-demand mode, the power of the sensor 203 is consumed in standby. The request transmitter and receiver 204 then transmits (returns) the received sensor data to the application 201 (the step S914 in FIG. 10 to the step S909 in FIG. 9). The current control process illustrated by the flowcharts in FIGS. 9 and 10 then ends.

When the battery level is equal to or greater than the prescribed value (Yes in the step S914), the data acquisition method switcher 209 transmits a request to cancel the request for notification-per-change, to the sensor 203 (step S915) and switches the data acquisition method from the notification-per-change mode to the on-demand mode. When the system load value exceeds the prescribed value, the number of data notifications from the sensor 203 in a prescribed time exceeds the prescribed value, the change in sensor data from the sensor 203 is within the prescribed value, and the battery level of the sensor 203 is equal to or greater than the prescribed value, the data acquisition method switcher 209 executes the following operation. The data acquisition method switcher 209 issues to the sensor 203, a request to cancel the notification-per-change mode in order to reduce the excess load on the system (step S915).

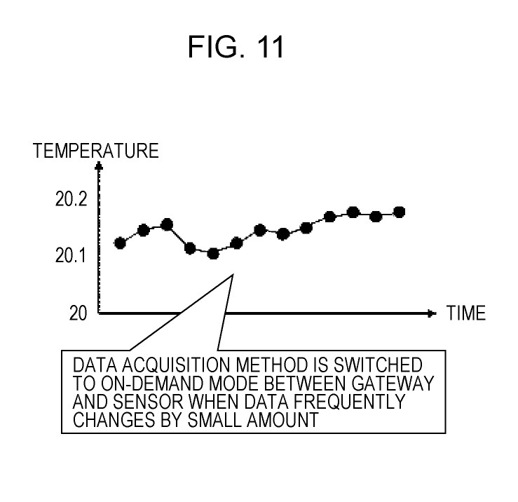

FIG. 11 illustrates an example of the sensor data pattern when the sensor 203 set to the notification-per-change mode as the current data acquisition method changes a little in measured value (No in the step S913) but the sensor 203 issues notifications frequently (Yes in the step S911). In such a case, if the sensor 203 transmits all sensor data that have changed, to the GW 202, the load on the sensor 203, GW 202, and the field area network between the GW 202 and sensor 203 will be increased. The data acquisition method switcher 209 therefore switches the data acquisition method for such a sensor 203, to the on-demand mode (FIG. 1A) in the following manner. This may reduce the excess load on the GW 202 (FIG. 3) and the field area network.

First, the data acquisition method switcher 209 determines the interval at which the sensor data of the sensor 203 is acquired in the on-demand mode (step S916).

Moreover, the data acquisition method switcher 209 sets a timer to control the interval of data acquisition in the on-demand mode (step S917). The data acquisition method switcher 209 calculates the interval of data acquisition in the on-demand mode based on the past change pattern of sensor data of the target sensor 203 and sets a timer that fires every calculated interval. The interval of data acquisition is set to a time taken for the value of sensor data to change by a prescribed value (5%, for example) in the past data, for example.

The request transmitter and receiver 204 then transmits (returns) the currently received sensor data to the application 201 (the step S917 in FIG. 10→the step S909 in FIG. 9). The current control process illustrated by the flowcharts in FIGS. 9 and 10 then ends.

When the data change is equal to or greater than the prescribed value (Yes in the step S913), the request transmitter and receiver 204 transmits (returns) the currently received sensor data to the application 201 (the step S913 in FIG. 10 to the step S909 in FIG. 9). The current control process illustrated by the flowcharts in FIGS. 9 and 10 then ends.

In the next control process illustrated in FIGS. 9 and 10 after the data acquisition method is switched to the on-demand mode by transmitting to the sensor 203, the request to cancel the notification request in the step S915 of FIG. 10, the determination by the request transmitter and receiver 204 is No in the steps S901 and S904 of FIG. 9. In this case, the sensor information acquisition section 206 then determines whether a timer event that occurs when the timer is up is received (No in the step S904 of FIG. 9→the step S918 of FIG. 10).

When the timer event is not received (No in the step S918), the sensor information acquisition section 206 does nothing and terminates the control process illustrated by the flowcharts in FIGS. 9 and 10.

When the timer event is received (Yes in the step S918), the sensor information acquisition section 206 polls the sensor 203 and acquires sensor data (step S919). The sensor information acquisition section 206 records the acquired sensor data and data acquisition time in the sensor history DB 207 in the same way as the step S905 of FIG. 9 (step S920).

The data acquisition method switcher 209 determines whether the acquired sensor data has changed by a certain value or more (step S921).

When the sensor data has changed (Yes in the step S921), the sensor information acquisition section 206 transmits (returns) the acquired sensor data to the application 201 (the step S922 of FIG. 10 to the step S909 of FIG. 9). The current control process illustrated by the flowcharts in FIGS. 9 and 10 then ends.

When the sensor data has not changed (No in the step S921), the request transmitter and receiver 204 does not transmit the acquired sensor data to the application 201 and terminates the control process illustrated by the flowcharts in FIGS. 9 and 10.

In the above description of the embodiments, the prescribed values used in the determination in the steps S602, S604, and S606 of FIG. 6, the steps S705 and S707 of FIG. 7, the steps S908 and S911 of FIG. 9, and the steps S913 and S914 of FIG. 10 may be dynamically varied. Some of the prescribed values may be set for each type of measured data of the sensors 203 or may be varied depending on the season and time.

The control processes illustrated by the above-described flowcharts in FIGS. 6, 7, 9, and 10 implement the effects described in the embodiments of FIGS. 2, 3, and 4. Specifically, even in the case of acquiring data from a single sensor, it is possible to reduce measurement, acquisition, or notification of unwanted sensor data in accordance with the change pattern of sensor data and the change pattern of data acquisition requests without being influenced by the other sensors. Even in an IoT system which includes limited calculation resources and network resources and in which a large number of sensors 203 are connected to the one GW 202, sensor data may be collected at proper timing while the system load is reduced. In other words, the method of acquiring data from sensors may be dynamically switched in accordance with the system condition, thus implementing both reduction in system load and data acquisition at appropriate time for applications.

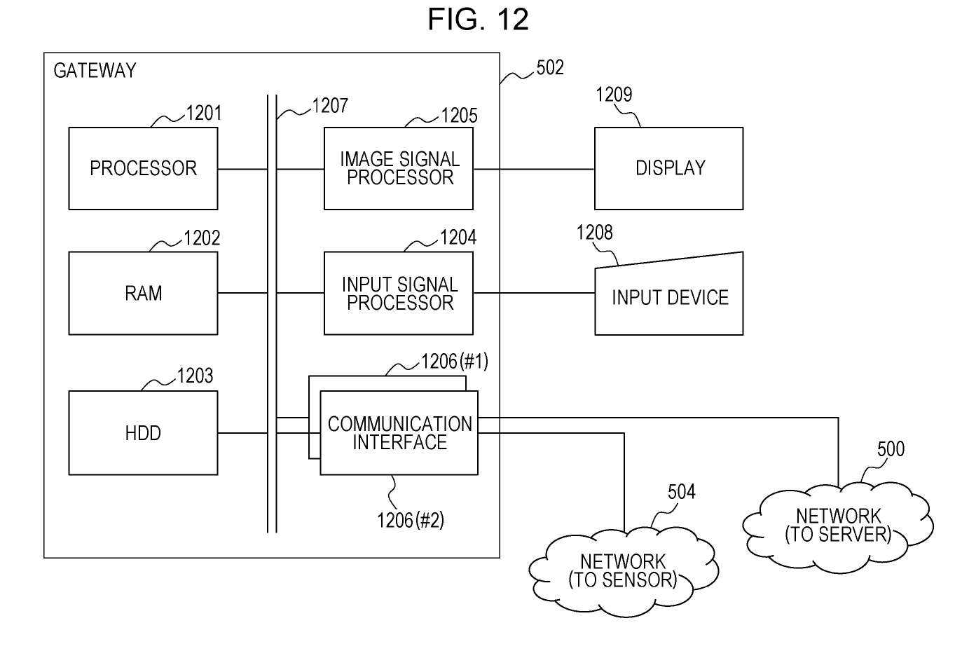

FIG. 12 is a block diagram illustrating a hardware configuration example of the GW 502 in the system configuration of FIG. 5 as the embodiment. In the GW 502, a processor 1201, a memory (including one or two or more random access memories (RAMs) 1202 and one or two or more hard disk drives (HDDs) 1203), an input signal processor 1204, an image signal processor 1205, and communication interfaces 1206#1 and 1206#2 are connected to each other through a bus 1207. The input signal processor 1204 is connected to an input device 1208 such as a keyboard and a mouse. The image signal processor 1205 is connected to a display 1209.

The processor 1201 loads a control processing program corresponding to each of the aforementioned embodiments from the HDD 1203 to the RAM 1202 for execution.

The processor 1201 temporarily stores program data of each control process described above, variable data processed during execution of the program, and other data in the RAM 1202 and uses the RAM 1202 as a working storage area during execution of the program.

The HDD 1203 saves and stores program data of each control process described above and stores data of the sensor history DB and request history DB.

The communication interface 1206#1 processes data exchanged between the GW 502 and the network 500 (FIG. 5) and relays communications between the GW 502 and the server 510 (FIG. 5). The communication interface 1206#2 processes data exchanged between the GW 502 and the field area network 504 (FIG. 5) and relays communications between the GW 502 and the sensors 503#1 to 503#3 (FIG. 5).

The input signal processor 1204 receives inputs of various types of operations for the input device 1208 by the user of the GW 502 and transfers the same to the processor 1201.

The image signal processor 1205 converts display data received from the processor 1201 into an image signal and displays the same on the display 1209.

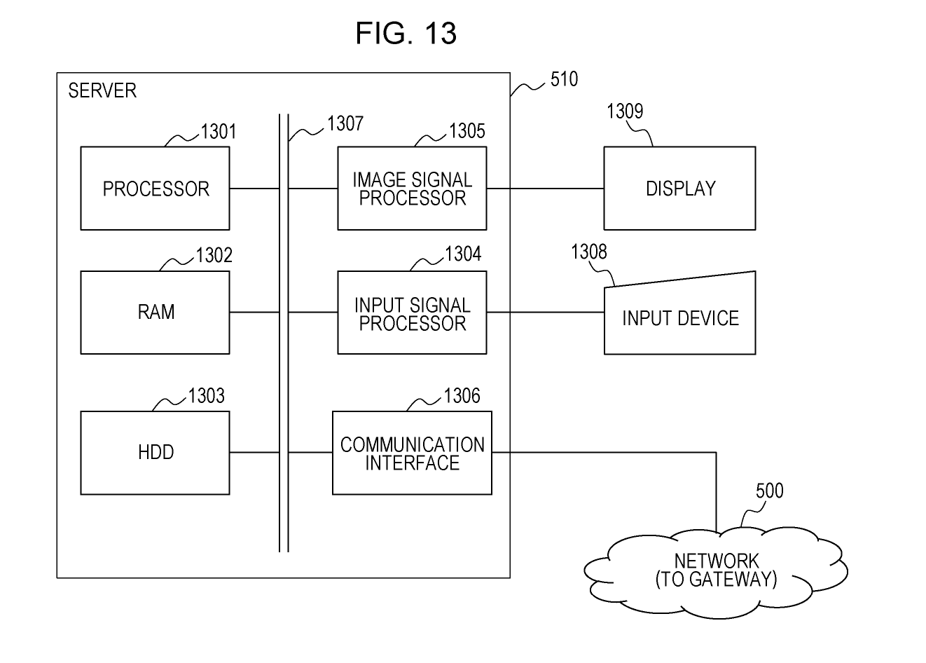

FIG. 13 is a block diagram illustrating a hardware configuration example of the server 510 in the system configuration of FIG. 5 as the embodiment. In the server 510, a processor 1301, a RAM 1302, an HDD 1303, an input signal processor 1304, an image signal processor 1305, and a communication interface 1306 are connected to each other through a bus 1307. The input signal processor 1304 is connected to an input device 1308 such as a keyboard and a mouse. The image signal processor 1305 is connected to a display 1309.

The processor 1301 loads the program of the application 501 (FIG. 5) from the HDD 1303 to the RAM 1302 for execution.

The processor 1301 temporarily stores program data of the application 501, variable data processed during execution of the program, and other data in the RAM 1302 and uses the RAM 1302 as a working storage area during execution of the program.

The HDD 1303 saves and stores the application program data of the application 501 and stores sensor data received from the GW 502.

The communication interface 1306 processes data exchanged between the server 510 and the network 500 (FIG. 5) and relays communications between the server 510 and the GW 502 (FIG. 5).

The input signal processor 1304 receives inputs of various types of operations for the input device 1308 by the user of the server 510 and transfers the same to the processor 1301.

The image signal processor 1305 converts display data received from the processor 1301 into an image signal and displays the same on the display 1309.

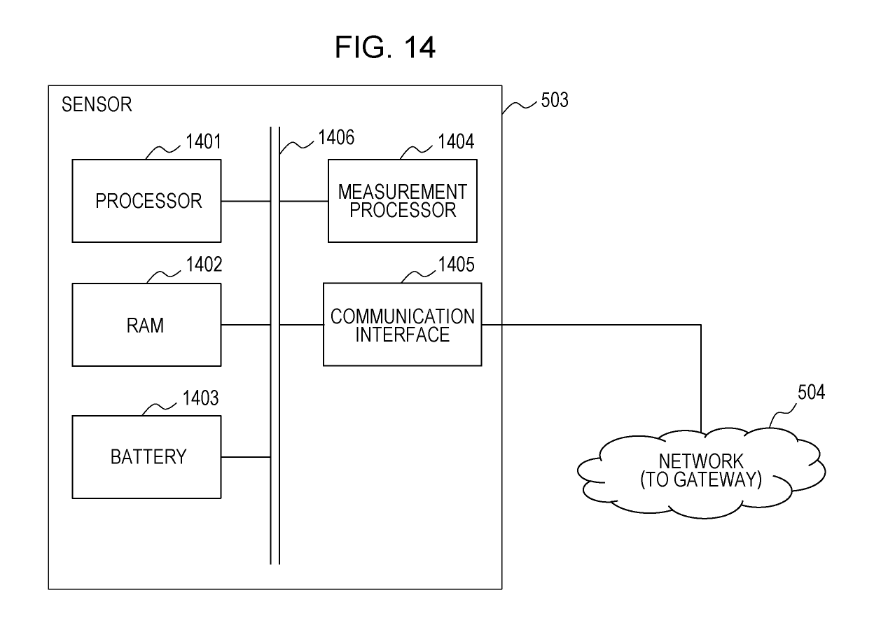

FIG. 14 is a block diagram illustrating a hardware configuration example of each of the sensors 503 (503#1 to 503#3, for example) in the system configuration of FIG. 5 as the embodiment. In the sensor 503, a processor 1401, a RAM 1402, a battery 1403, a measurement processor 1404, and a communication interface 1405 are connected to each other through a bus 1406.

The measurement processor 1404 is a sensor element. For example, in the sensor 503#1 (FIG. 5), the measurement processor 1404 is a temperature measurement device; in the sensor 503#2, a CO₂ gas detection device; and in the sensor 503#3, a power measurement device.

The processor 1401 loads a measurement program backed up by the battery 1403 in the RAM 1402 for execution. The measurement program may be loaded from a read-only-memory (ROM, particularly not-illustrated) or the like to the RAM 1402 for execution. In this process, when the notification-per-change mode is set by the GW 502, the processor 1401 executes the following operation. When the sensor data (measured value) acquired from the measurement processor 1404 has changed, the processor 1401 transmits the sensor data to the GW 502 (FIG. 5) through the communication interface 1405 via the field area network 504. When the on-demand mode is set by the GW 502, the processor 1401 executes the following operation. When being notified of a request to acquire sensor data by the GW 502, the processor 1401 transmits sensor data acquired from the measurement processor 1404 to the GW 502 through the communication interface 1405 via the field area network 504.

The processor 1401 temporarily stores data of the aforementioned measurement program, variable data processed during execution of the program, and other data in the RAM 1402 and uses the RAM 1402 as a working storage area during execution of the program.

The communication interface 1405 processes data exchanged between the sensor 503 and the field area network 504 (FIG. 5) and relays communications between the sensor 503 and the GW 502 (FIG. 5).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus comprising:
a first memory;
a second memory; and
a processor configured to:
store data acquisition requests received from an application in the first memory,
acquire sensor data from a sensor,
store the sensor data acquired from the sensor in the second memory,
determine a system condition based on the data acquisition requests stored in the first memory and the sensor data stored in the second memory, and
switch a method of acquiring sensor data from the sensor based on the determined system condition.

2. The communication apparatus according to claim 1, wherein the system condition determined by the processor is a load of the communication apparatus.

3. The communication apparatus according to claim 1, wherein the system condition determined by the processor is a battery level of the sensor.

4. The communication apparatus according to claim 1, wherein the processor switches the method of acquiring sensor data from the sensor to an on-demand data acquisition method.

5. The communication apparatus according to claim 4, wherein
the processor:
detects a change pattern of the sensor data based on the sensor data stored in the second memory, and
determines a data acquisition interval in the on-demand data acquisition method and the method of acquiring sensor data based on the detected change pattern of the sensor data.

6. The communication apparatus according to claim 4, wherein
the processor:
detects a request pattern of the data acquisition requests based on the data acquisition requests stored in the first memory, and
determines a data acquisition interval in the on-demand data acquisition method and the method of acquiring sensor data based on the detected request pattern of the data acquisition requests.

7. The communication apparatus according to claim 1, wherein the processor switches the method of acquiring sensor data from the sensor to a method of acquiring data by notification from the sensor upon change in the sensor data.

8. The communication apparatus according to claim 7, wherein the processor withholds an operation to switch the method of acquiring sensor data to an on-demand data acquisition method depending on a battery level acquired from the sensor.

9. The communication apparatus according to claim 1, wherein the processor acquires sensor data from a single sensor.

10. A system comprising:
a server configured to execute an application; and
a communication apparatus including
a first memory,
a second memory, and
a processor configured to
store data acquisition requests received from an application in the first memory,
acquire sensor data from a sensor,
store the sensor data acquired from the sensor in the second memory,
determine a system condition based on the data acquisition requests stored in the first memory and the sensor data stored in the second memory, and
switch a method of acquiring sensor data from the sensor based on the determined system condition.

11. A control method executed by a computer, comprising:
receiving data acquisition requests from an application;
storing the data acquisition requests received from the application;
acquiring sensor data from a sensor;
storing the sensor data acquired from the sensor;
determining a system condition based on the stored data acquisition requests and the stored sensor data; and
switching a method of acquiring sensor data from the sensor based on the determined system condition.

12. The control method according to claim 11, wherein the system condition is a load of the computer.

13. The control method according to claim 12, the control method further comprising:
calculating a change in sensor data when the load of the computer is equal to or greater than a prescribed value.

14. The control method according to claim 13, wherein when the change is less than a prescribed value and when the method of acquiring sensor data is currently an on-demand acquisition method,
switching the method of acquiring sensor data to an acquisition-per-change method.

15. The control method according to claim 13, wherein when the change is less than a prescribed value and when the method of acquiring sensor data is not currently an on-demand acquisition method,
calculating the number of notifications from the sensor, and
switching the method of acquiring sensor data to the on-demand acquisition method when the number of notifications is less than a prescribed value.

16. The communication apparatus according to claim 1, wherein the first memory and the second memory are the same.

17. The system according to claim 10, wherein the first memory and the second memory are the same.

18. A communication control process executed by a gateway device, the communication control process comprising:
receiving data acquisition requests from a server application communicatively connected to the gateway device;
storing the data acquisition requests;
acquiring sensor data from a plurality of sensors communicatively connected to the gateway device;
storing the sensor data;
calculating a load of the gateway device based on the quantity of data acquisition requests received from the application and the quantity of sensor data received from the plurality of sensors during a time period; and
switching a method of acquiring sensor data from the plurality of sensors based on the calculated load.
